(19) United States
(12) Patent Application Publication
(10) Pub. No.: US 2026/0010495 A1
(43) Pub. Date: Jan. 8, 2026

(54) DISTRIBUTED RING-BASED INTERCONNECT FOR REGISTER ACCESSIBILITY IN A SYSTEM-ON-CHIP

(71) Applicant: QUALCOMM INCORPORATED, San Diego, CA (US)

(72) Inventors: Nitin MAKHIJA, San Jose, CA (US); Shivam GUPTA, Pflugerville, TX (US); Mohd Imran BEG, Whitby (CA); Mohsen NAJAFI YAZDI, Kingston (CA)

(21) Appl. No.: 18/765,063

(22) Filed: Jul. 5, 2024

(51) Int. Cl. G06F 13/20

(52) U.S. Cl. CPC G06F 13/20; G06F 2213/40

(57) ABSTRACT

A data communication interconnect or network in a system-on-chip (SoC) may include one or more routers, each coupled to one or more register rings. A router may receive transaction request packets from an initiator and provide transaction response packets to the initiator. Each register ring may have an input end and an output end, providing a unidirectional data communication path for the request and response packets. Each register ring may have one or more nodes, each having one or more registers that may be the targets of write and read transactions associated with the request packets. The input and output ends of register rings may be coupled to ring interfaces of the router, which may provide paths for request packets and response packets.

### DESCRIPTION OF THE RELATED ART

A computing device may include multiple subsystems, cores, logic circuitry components, etc. Such a computing device may be, for example, a portable computing device, such as a laptop or palmtop computer, a cellular telephone or smartphone, an Internet-of-Things (IOT) device, a wearable device, an automotive computing device, etc. The multiple subsystems, cores and other components of a computing device may be included within different chips or in the same integrated circuit chip. A “system-on-chip” or “SoC” is an example of one such chip that integrates numerous components to provide system-level functionality. For example, a SoC may include one or more types of processors, such as central processing units (CPUs), graphics processing units (GPUs), digital signal processors (DSPs), neural processing units (NPUs), etc. An SoC may include other processing subsystems, such as a transceiver or “modem” subsystem that provides wireless connectivity, a memory subsystem, etc.

An SoC may include numerous general-purpose registers, which may also be referred to as control and status registers (CSRs). Such registers may be used by various processing subsystems to read status information stored in the registers by various SoC logic circuitry components, and to change configuration settings used by such logic circuitry components. The CSRs may be in proximity with the logic circuitry components that access the registers. Accordingly, the registers may be widely distributed over the physical area of the SoC. The SoC may include one or more data communication interconnects configured to transfer data between the processing subsystems and the CSRs.

Interconnect architectures have been developed to address the problem of congestion in routing data communication interconnect signal paths (i.e., wires) in an SoC. A data communication interconnect architecture may have, for example, a ring topology, in which communicating components are distributed along a single path, with the input and output ends of the path coupled to a data communication hub. Alternatively, a data communication interconnect architecture may have a star topology, in which multiple signal paths radiate outwardly from a data communication hub to communicating components. It would be desirable to provide a data communication interconnect that may further reduce SoC signal path routing congestion and provide other advantages.

### SUMMARY OF THE DISCLOSURE

Systems, methods and other examples are disclosed for data communication in a system-on-chip (SoC).

An exemplary system for data communication in an SoC may include at least one router and a plurality of register rings. A router may include a master request input port configured to receive register access request packets from an initiator and a master response output port configured to provide register access response packets to the initiator. The router may further include at least a first ring interface and a second ring interface. Each ring interface may include a ring request output port and a ring response input port. Each register ring may include at least one register in a unidirectional data communication path between an input end and an output end of the register ring. The input end of each register ring may be coupled to a ring request output port of the router and may be configured to receive register access request packets from the router. The output end each register ring may be coupled to a ring response input port of the router and may be configured to provide register access response packets to the router.

An exemplary method for data communication in a SoC may include receiving, by a master request input port of a router, a register access request packet from an initiator. The method may also include providing, by a first ring request output port of the router or a second ring request output port of the router, the register access request packet to a ring input end of a first register ring or a second register ring. The method may still further include receiving, by a first ring response input port or a second ring response input port, a register access response packet from a ring output end of the first register ring or the second register ring. The method may yet further include providing, by a master response output port of the router, the register access response packet to the initiator.

An exemplary SoC may include a plurality of registers, a plurality of logic circuitry components configured to access the plurality of registers, and at least one router. The router may have a master request input port configured to receive register access request packets from an initiator addressed to the plurality of registers. The router may also have a master response output port configured to provide register access response packets to the initiator. The router may further have a first ring interface including a first ring request output port and a first ring response input port. The router may still further have a second ring interface including a second ring request output port and a second ring response input port. The plurality of registers may be included in a plurality of register rings, including a first register ring and a second register ring. Each register ring may include at least one of the plurality of registers in a unidirectional data communication path between a ring input end and a ring output end of the register ring. The ring input end of the first register ring may be coupled to the first ring request output port of the router. The ring output end of the first register ring may be coupled to the first ring response input port of first router. The ring input end of the second register ring may be coupled to the second ring request output port of the router. The ring output end of the second register ring may be coupled to the second ring response input port of the router.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an example of a data interconnect or network system in a system-on-chip (SoC), in accordance with exemplary embodiments.

FIG. 2 is a timing diagram illustrating an example of operation of the data interconnect or network system of FIG. 1.

FIG. 3 is a continuation of the timing diagram of FIG. 1.

FIG. 4 is a block diagram of another example of a data interconnect or network system in an SoC, in accordance with exemplary embodiments.

FIG. 5 is a block diagram of a node of a data interconnect or network system in an SoC, in accordance with exemplary embodiments.

FIG. 6 is a block diagram of a router of a data interconnect or network system in an SoC, in accordance with exemplary embodiments.

FIG. 7 is a block diagram of a first-in-first-out (FIFO) buffer having a clock domain crossing feature, in accordance with exemplary embodiments.

FIG. 8 is a block diagram of portions of a data interconnect or network system having a voltage domain crossing feature, in accordance with exemplary embodiments.

FIG. 9 is a flow diagram illustrating a method for data communication in an SoC, in accordance with exemplary embodiments.

FIG. 10 is a block diagram of a portable computing device having an SoC configured with a data interconnect or network system, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

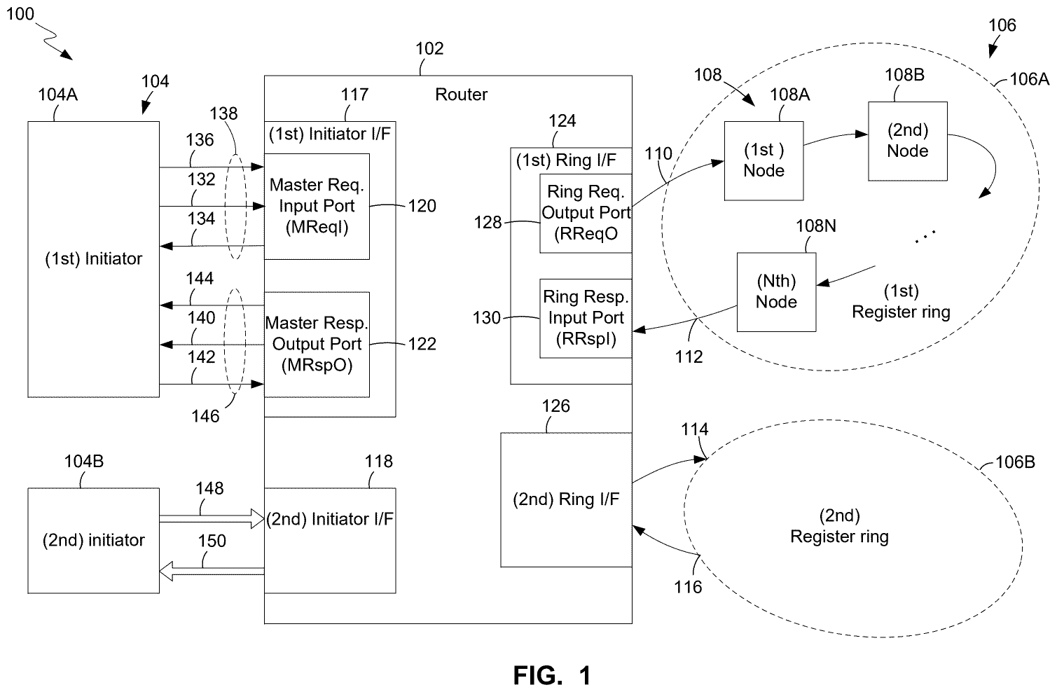

As shown in FIG. 1, in an illustrative or exemplary embodiment a system 100 may include a router 102. The system 100 may further include any number of transaction initiators 104 (also referred to for brevity as initiators 104), including, for example, a first initiator 104A and a second initiator 104B. The system 100 may also include two or more register rings 106, including, for example, a first register ring 106A and a second register ring 106B. Each register ring 106 may include any number (N) of nodes 108, including, for example, a first node 108A, a second node 108B, etc., through an Nth node 108N. The nodes 108 of the first register ring 106A may be distributed along a path between an input end 110 of the first register ring 106A and an output end 112 of the first register ring 106A. Stated another way, the nodes 108 form a path having an input end 110 and an output end 112. The terms “input end” and “output end” relate to the unidirectional nature of the data packet communication, which is described below. Although not shown for purposes of clarity, to meet timing constraints any number of signal repeaters (e.g., flip-flops) may be included between any of the nodes 108.

The second register ring 106B may similarly have an input end 114 and an output end 116. For purposes of clarity, the structure of only the first register ring 106A (e.g., nodes 108A-108N) is shown; the structures of other register rings 106 are not shown because they are similar to the structure of the first register ring 106A. It should be noted, however, that the register rings 106 may differ in number of nodes.

Although not shown in FIG. 1 for purposes of clarity, each node 108 may include any number of registers. The system 100 may be a portion of a system-on-chip (SoC), other portions of which are not shown in FIG. 1. These registers may be of the type that may be referred to as control and status registers (CSRs). Various other SoC portions or components may store data in CSRs and read data from CSRs. Although the nodes 108 may be distributed along paths of their respective register rings 106 as described above, it should be understood that the nodes 108 also may be distributed about the area of the SoC. For example, each node 108 may be located in proximity to a logic circuitry component that stores data in or reads data from that node's registers.

An initiator 104 may be any type of component configured to initiate read or write transactions directed to the registers. A straightforward example of an initiator 104 is a processing subsystem, such as a central processing unit (CPU). A logic circuitry component (not shown) may be any type of component configured to directly access a register (e.g., CSR). A straightforward example of a logic circuitry component is a counter. Using the example of a counter that is coupled directly to one or more CSRs, an initiator 104, such as a CPU, may store data in a CSR that configures or controls the counter, and may read the counter's count using a CSR. Nevertheless, in some examples a logic circuitry component configured to directly access a CSR may include a processing subsystem.

The term “ring” is used herein to refer to a network topology and is not intended to describe or limit the shape of the path along which the registers are located; a register ring 106 (i.e., its path) may have any shape, including an irregular shape, and its registers may be located anywhere on the path. Note that the register rings 106 are illustrated in a conceptual manner in FIG. 1, and in a physical implementation may extend on the SoC in any direction from the router 102. The register rings 106 may extend in substantially different directions on the SoC to reach the different regions of the SoC in which logic circuitry components that store data in or read data from the registers of that ring's nodes may be located. The two register rings 106A and 106B could extend from the router 102 in directions that are, for example, 180 degrees from each other. More generally, any number of register rings 106 may extend from such a router at any angles or other orientations with respect to each other and the router. Such a star network-like topology, in which multiple register rings extend in different directions away from a router, may enable data communication with logic circuitry components in widely differing locations on the SoC while reducing signal path routing congestion.

The system 100 may be configured to provide networked data communication between the initiators 104 and the registers (not separately shown) of the nodes 108. That is, an initiator 104 may be configured to send data to any selected one of the registers and to receive or read data from any selected one of the registers. Each register in the system 100 may have a unique address, which may be used to identify a register as the target of a transaction. An initiator 104 may be configured to initiate a read transaction with a register by sending a register access request packet (not shown) that includes information identifying the transaction type as a read transaction and includes the register's address. Similarly, an initiator 104 may be configured to initiate a write transaction with a register by sending a register access request packet (not shown) that includes information identifying the transaction type as a write transaction and includes the register's address. In some examples (not shown), a protocol converter may be included that converts between a data communication protocol used by an initiator and a different data communication protocol used by a router.

In response to a node 108 receiving a register access request packet carrying an address that identifies the register as the target of the transaction and information that identifies the transaction type as a write, the node 108 may store in the targeted register data that is the payload of the received register access request packet. In response to a node 108 receiving a register access request packet carrying an address that identifies the register as the target of the transaction and information that identifies the transaction type as a read, the node 108 may read data stored in the targeted register. A determination by a node 108 that a received register access request packet targets one of the node's registers may be referred to as a “hit.” In response to a hit, the node 108 may form a register access response packet (not shown). The node 108 may include in the payload of the register access response packet the data read from the register when the transaction type is a read. The node 108 may include in the register access response packet information indicating the status of the read or write transaction (e.g., acknowledging the transaction was completed) or other information.

The router 102 may include a first initiator interface 117 configured to interface data communication signals between the router 102 and the first initiator 104A. Likewise, the router 102 may include a second initiator interface 118 configured to interface data communication signals between the router 102 and the second initiator 104B. The first initiator interface 117 may include a master request input port (MReqI) 120 configured to receive register access request packets from the first initiator 104A, and a master response output port (MRspO) 122 configured to provide register access response packets to the first initiator 104A. As the structure of the second initiator interface 118 may be similar to the structure of the first initiator interface 117, including the aforementioned ports, such structure is not shown in similar detail. Although in the illustrated example the router 102 includes two initiator interfaces 117 and 118, corresponding to the two initiators 104A and 104B, in other examples (not shown) such a router may include any number of such initiator interfaces to accommodate up to the corresponding number of initiators.

The router 102 may include a first ring interface 124 configured to interface data communication signals between the router 102 and the first register ring 106A. Likewise, the router 102 may include a second ring interface 126 configured to interface data communication signals between the router 102 and the second register ring 106B. The first ring interface 124 may include a ring request output port (RReqO) 128 coupled to the input end 110 of the first register ring 106A and configured to provide register access request packets from the router 102 to the first register ring 106A. The first ring interface 124 may also include a ring response input port (RRspI) 130 coupled to the output end 112 of the first register ring 106A and configured to enable the router 102 to receive register access response packets from the first register ring 106A. As the structure of the second ring interface 126 may be similar to the structure of the first ring interface 124, including the aforementioned ports, such structure is not shown in similar detail. Although in the illustrated example the router 102 includes two ring interfaces 124 and 126, corresponding to the two register rings 106A and 106B, in other examples (not shown) such a router may include any number of such ring interfaces to accommodate up to the corresponding number of register rings.

Although an example of operation of the system 100 is described below, it may first be appreciated that register access request packets (not shown) provided by the ring request output port 128 may be conveyed or passed from node to node along the first register ring 106A in a direction from the input end 110 to the output end 112. Note that the topology of the nodes 108 may be described as a chain as well as a ring. The first node 108A may receive each register access request packet and determine whether the register access request packet targets one of its registers (not shown in FIG. 1). If the first node 108A determines that the register access request packet does not target one of its registers, the first node 108A may pass the register access request packet to the second node 108B, i.e., the next node 108 in the chain. Each successive node 108 in the ring or chain of nodes 108 may operate in this same manner. If any one of the nodes 108 determines that the register access request packet targets one of its registers, that node 108 may respond to the transaction request. If the request is for a write transaction, then the node 108 may write data contained in the payload portion of the register access request packet to the targeted register. If the request is for a read transaction, then the node 108 may read data from the targeted register. The node 108 may complete the transaction by forming a register access response packet (not shown) and sending it to the next node 108 in the chain. Each node 108 that receives a register access response packet may pass the register access response packet to the next node 108 or, if the node 108 is the last or Nth node 108N, to the ring response input port 130.

The first and second initiator interfaces 117 and 118 (and any additional such initiator interfaces in examples (not shown) having more than two) may operate using a handshaking protocol. In an example the handshaking protocol is based on two signals, which may be referred to as Valid and Ready. With regard to the first initiator interface 117, such signals may include a Master Request Valid signal 132 provided by the first initiator 104A, and a Master Request Ready signal 134 provided by the master request input port 120 of the router 102. When the master request input port 120 is capable of receiving one or more register access request packets, the master request input port 120 may assert the Master Request Ready signal 134. The first initiator 104A may assert the Master Request Valid signal 132 to indicate to the master request input port 120 of the router 102 that the first initiator 104A is providing a register access request packet (payload) 136. Only when both the Master Request Valid signal 132 and the Master Request Ready signal 134 are asserted may a transfer of the register access request packet (payload) 136 from the first initiator 104A to the router 102 occur. The handshaking protocol may also involve a clock signal, which is not shown in FIG. 1 for purposes of clarity. Thus, on each clock cycle in which the Master Request Valid signal 132 and the Master Request Ready signal 134 are asserted, one register access request packet (payload) 136 may be transferred from the first initiator 104A to the router 102. The Master Request Valid signal 132, the Master Request Ready signal 134, and the register access request packet (payload) 136 may be provided through a first master request signal path 138. Stated another way, the first master request signal path 138 couples the first initiator 104A to the first master request input port 120 of the router 102.

The first initiator interface signals may further include a Master Response Valid signal 140 provided by the master response output port 122 of the router 102, and a Master Response Ready signal 142 provided by the first initiator 104A. When the first initiator 104A is capable of receiving one or more register access response packets, the first initiator 104A may assert the Master Response Ready signal 142. The master response output port 122 of the router 102 may assert the Master Response Valid signal 140 to indicate to the first initiator 104A that the master response output port 122 of the router 102 is providing a register access response packet (payload) 144. On each clock cycle in which the Master Response Valid signal 140 and the Master Response Ready signal 142 are asserted, one register access response packet (payload) 144 may be transferred from the router 102 to the first initiator 104A. The Master Response Valid signal 140, the Master Response Ready signal 142, and the register access response packet (payload) 144 may be provided through a first master response signal path 146. Stated another way, the first master response signal path 146 couples the first master response output port 122 of the router 102 to the first initiator 104A.

A second master request signal path 148 and second master response signal path 150 may couple the second initiator 104B to the second initiator interface 118 of the router 102. As the structure and operation (i.e., Valid/Ready handshaking protocol) of the second master request signal path 148 and second master response signal path 150 may be similar to the above-described structure and operation of the first master request signal path 138 and first master response signal path 146, such aspects are not described or shown in similar detail in FIG. 1. The above-described Valid/Ready handshaking protocol is intended only as an example. Although not described in similar detail herein, another example of a handshaking protocol that may be used is commonly referred to as a Credit/Debit protocol.

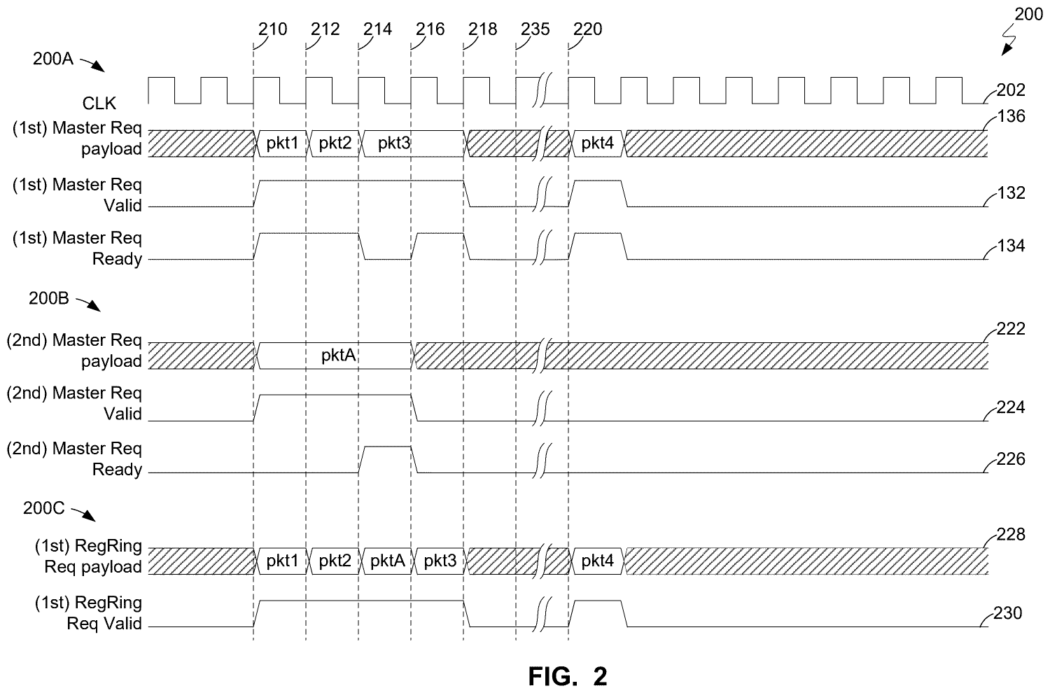

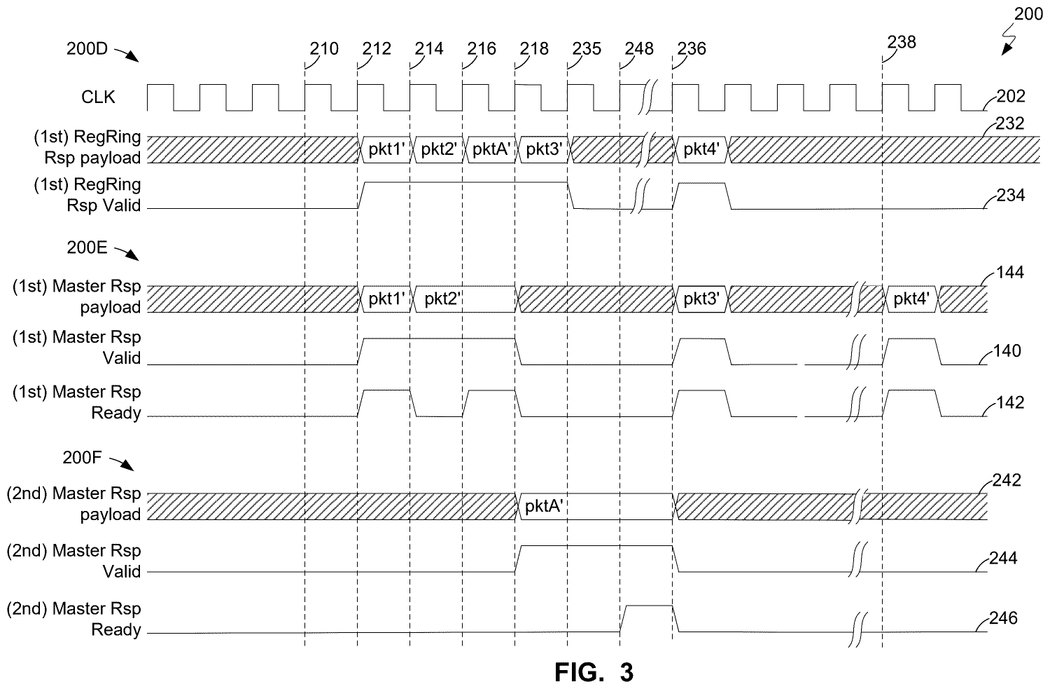

In FIGS. 2-3, a timing diagram 200 may illustrate an example of operation of the above-described system 100 (FIG. 1). The timing diagram 200 is shown in six portions 200A (FIG. 2), 200B (FIG. 2), 200C (FIG. 2), 200D (FIG. 3), 200E (FIGS. 3), and 200F (FIG. 3), corresponding to the operation of different portions of the system 100.

In the first portion 200A of the timing diagram 200, the following signals described above with regard to FIG. 1 are shown: the register access request packet (payload) 136, which may also be referred to as a first Master Request payload 136; the Master Request Valid signal 132, which may also be referred to as a first Master Request Valid signal 132; and the Master Request Ready signal 134, which may also be referred to as a first Master Request Valid signal 134. A clock signal 202 is also shown in the timing diagram 200.

As illustrated in the first portion 200A, at a time 210 the first master or initiator 104A (FIG. 1) may assert the first Master Request Valid signal 132 and provide a register access request packet pkt1 (in the form of the first Master Request payload 136). At the same time 210, the master request input port 120 of the router 102 (FIG. 1) may assert the first Master Request Ready signal 134. This combination of signals may result in the transfer of the register access request packet pkt1 from the first master or initiator 104A to the router 102.

The first master or initiator 104A (FIG. 1) may continue to assert the first Master Request Valid signal 132 and provide another register access request packet pkt2 (in the form of the first Master Request payload 136) at a time 212 and still another register access request packet pkt3 at a time 214. The master request input port 120 of the router 102 (FIG. 1) may continue to assert the first Master Request Ready signal 134 at the time 212 but de-assert it at time 214. This combination of signals may result in the transfer of the register access request packet pkt2 from the first master or initiator 104A to the router 102 but not the register access request packet pkt3, because the router 102 may not be ready to receive the register access request packet pkt3 due to so-called back-pressure. Back-pressure is a term that may be used in a data transfer system when there is a fast sender of data, which in the illustrated example is the first master or initiator 104A, and a slower receiver of data, which in the illustrated example is the router 102. The router 102 may be receiving data more slowly because, for example, the router 102 may be performing other operations. Then, at a time 216 the master request input port 120 of the router 102 (FIG. 1) may re-assert the first Master Request Ready signal 134 while the first Master Request Valid signal 132 remains asserted. This combination of signals may result in the transfer of the register access request packet pkt3 from the first master or initiator 104A to the router 102. Then, at a time 218 the first master or initiator 104A may de-assert the Master Request Valid signal 132, and the master request input port 120 of the router 102 may de-assert the first Master Request Ready signal 134.

Later, at a time 220 the first master or initiator 104A may assert the first Master Request Valid signal 132 for one clock cycle and provide still another register access request packet pkt4 (in the form of the first Master Request payload 136). At the same time 220, the master request input port 120 of the router 102 (FIG. 1) may assert the first Master Request Ready signal 134 for one clock cycle, resulting in the transfer of the register access request packet pkt4 from the first master or initiator 104A to the router 102.

In the second portion 200B of the timing diagram 200, the following signals are shown: a second Master Request payload 222, which may be an example of a signal included in the above-described master request signal path 148 (FIG. 1) provided by the second master or initiator 104B; a second Master Request Valid signal 224, which may be an example of another signal included in the above-described master request signal path 148; and a second Master Request Ready signal 226, which may be an example of another signal included in the above-described master request signal path 148.

As illustrated in the second portion 200B, at time 210 the second master or initiator 104B (FIG. 1) may assert the second Master Request Valid signal 224 and provide a register access request packet pktA (in the form of the second Master Request payload 222). However, in this example, due to back-pressure it is not until time 214 in the illustrated example that the second initiator interface 118 of the router 102 (FIG. 1) asserts the second Master Request Ready signal 226. The transfer of the register access request packet pktA from the second master or initiator 104B to the router 102 is thus delayed until after time 214. Then, at time 216 the second master or initiator 104B de-asserts the second Master Request Valid signal 224, and the second initiator interface 118 of the router 102 de-asserts the second Master Request Ready signal 226.

In the third portion 200C of the timing diagram 200, a first register ring request payload signal 228 and a first register ring request Valid signal 230 are shown. The register ring request payload signal 228 and the register ring request Valid signal 230 may be examples of signals provided by the above-described ring request output port 128 (FIG. 1) of the first ring interface 124. These signals may be provided to the first register ring 106A. Similar signals may be provided by the second ring interface 126 to the second register ring 106B but are not shown because they are not involved in the illustrated example of operation.

At time 210, the ring request output port 128 (FIG. 1) may assert the first register ring request Valid signal 230 for four clock cycles. During each clock cycle in which the first register ring request Valid signal 230 is asserted, the ring request output port 128 (FIG. 1) may provide one of the above-referenced register access request packets pkt1, pkt2, pkt3, and pktA (in the form of the first register ring request payload signal 228). The order or sequence in which the ring request output port 128 provides the register access request packets may be determined based on data buffering in the router 102 and an arbitration protocol, which are aspects of the router 102 described below with regard to corresponding structural features. The arbitration protocol may be of any type. In the illustrated example, the arbitration protocol may be round-robin, in which the ring request output port 128 provides the register access request packets in the order or sequence that the register access request packets arrive at the ring request output port 128 through the router 102.

Due to the above-described instances of back-pressure in the illustrated example, the order in which the register access request packets arrive at the ring request output port 128 (FIG. 1) may be: pkt1, pkt2, pktA, pkt3. Note that one of these register access request packets arrives at the ring request output port 128 during each of four successive clock cycles, and the order or sequence in which they are received may depend upon buffering and arbitration in the router 102. In the illustrated example, at time 218, after pkt3 arrives at the ring request output port 128, no further valid register access request packets arrive until pkt4 at the time 220. Accordingly, the ring request output port 128 may assert the first register ring request Valid signal 230 for four clock cycles beginning at the time 210 while providing the four successive register access request packets in the order or sequence: pkt1, pkt2, pktA, pkt3, then de-assert the first register ring request Valid signal. Then, at time 230 the ring request output port 128 may assert the first register ring request Valid signal 230 for only one clock cycle while providing the register access request packet pkt4.

The register request access packets provided by the ring request output port 128 (FIG. 1) may be conveyed by the nodes 108 in the above-described order or sequence from node to node along the first register ring 106A. In the illustrated example, each of the register access request packets pkt1, pkt2, pktA, pkt3, and pkt4 targets one of the registers of the nodes 108 of the register ring 106A. Accordingly, the one or more nodes 108 that include the targeted registers provide register access response packets. The register access response packets may be conveyed or passed by any further nodes 108 until they reach the last node 108N (FIG. 1), which may in turn provide the register access response packets to the ring response input port 130 of the router 102 (FIG. 1).

Continuing the flow diagram 200 on FIG. 3 to the fourth portion 200D, a first register ring response payload signal 232 and a first register ring response Valid signal 234 are shown. The first register ring response payload signal 232 and the first register ring response Valid signal 234 may be examples of signals provided by the output end 112 of the first register ring 106A to the ring response input port 130 of the router 102 (FIG. 1).

As illustrated in the fourth portion 200D, the register access response packets pkt1′, pkt2′, pktA′, and pkt3′ are provided (in the form of the first register ring response payload signal 232) during four successive clock cycles beginning at time 212 and ending at a time 235. At a still later time 236 the register access response packet pkt4′ is provided. Accordingly, the ring response input port 130 may assert the first register ring response Valid signal 234 for four clock cycles beginning at time 212 (de-asserting at time 235) while providing the four successive register access request packets, and then re-assert the first register ring response Valid signal for one clock cycle at time 236. Note in the illustrated example that there is a latency of one clock cycle between the sequence of register access request packets pkt1, pkt2, pktA, pkt3, and pkt4 being provided by the router 102 to the input end of the register ring 106A beginning at the time 210 (as shown in portion 200C) and the corresponding sequence of register access response packets pkt1′, pkt2′, pktA′, pkt3′ and pkt4′ being received by the router 102 at the output end of the register ring 106A beginning at the time 212 (as shown in portion 200D). Nevertheless, in other examples such latency could be more than one clock cycle.

In the router 102 (FIG. 1), the register access response packets pkt1′, pkt2′, pkt3′, and pkt4′ received from the register ring 106A in the illustrated example may be provided to the first initiator interface 117. The register access response packet pktA′ received from the register ring 106A in the illustrated example may be provided to the second initiator interface 118. Signals relating to these transfers may operate as follows.

In the fifth portion 200E of the timing diagram 200, the following signals described above with regard to FIG. 1 are shown: the register access response packet (payload) 144, which may also be referred to as the first Master Response payload 144; the Master Response Valid signal 140, which may also be referred to as the first Master Response Valid signal 140; and the Master Response Ready signal 142, which may also be referred to as the first Master Response Ready signal 142.

As illustrated in the fifth portion 200E, at time 212 the master response output port 122 (FIG. 1) may assert the first Master Response Valid signal 140 and provide the register access response packet pkt1′ (in the form of the first Master Response payload 144). At the same time 212, the first master or initiator 104A (FIG. 1) may assert the first Master Response Ready signal 142. This combination of signals may result in the transfer of the register access response packet pkt1′ from the router 102 to the first master or initiator 104A. The master response output port 122 may continue to assert the first Master Response Valid signal 140 at time 214 and provide the register access response packet pkt2′ (in the form of the first Master Response payload 144). However, in the illustrated example, due to back-pressure, the first master or initiator 104A de-asserts the first Master Response Ready signal 142 at the time 214 for one clock cycle, and then re-asserts the first Master Response Ready signal 142 at the time 216 for one clock cycle. Accordingly, the register access response packet pkt1′ may be transferred to the first initiator 104A beginning at time 212, but the transfer of the register access response packet pkt2′ is delayed until after the time 216. Note that this delay results in the delay of all subsequent register access response packets destined to the first master or initiator 104A, which in the illustrated example are the register access response packets pkt3′ and pkt4′. In the illustrated example, the transfer of the register access response packets pkt3′ and pkt4′ are delayed until time 236 and time 238, respectively. That is, at time 236 the first master or initiator again asserts the first Master Response Ready signal 142, and the master response output port 122 asserts the first Master Response Valid signal 140, resulting in the transfer of the register access response packet pkt3′. After the transfer of the register access response packet pkt3′, the first master or initiator de-asserts the first Master Response Ready signal 142, and the master response output port 122 de-asserts the first Master Response Valid signal 140. Then, at time 238 the first master or initiator again asserts the first Master Response Ready signal 142, and the master response output port 122 asserts the first Master Response Valid signal 140, resulting in the transfer of the register access response packet pkt4′.

In the sixth portion 200F of the timing diagram 200, the following signals are shown: a second Master Response payload 242, which may be an example of a signal included in the above-described master response signals 150 (FIG. 1) provided by the second master or initiator 104B; a second Master Response Valid signal 244, which may be an example of another signal included in the above-described master request signal path 150; and second Master Response Ready signal 246, which may be an example of another signal included in the above-described master request signal path 150.

As illustrated in the sixth portion 200F, at time 218 the second initiator interface 118 (FIG. 1) asserts the second Master Response Valid signal 244 and provides the register access response packet pktA′ (in the form of the second Master Response payload 242). However, in this example, due to back-pressure it is not until a time 248 that the second master or initiator 104B (FIG. 1) asserts the second Master Response Ready signal 246. The transfer of the register access response packet pktA′ from the router 102 to the second master or initiator 104B is thus delayed until after the time 248. Then, at the time 236 the second initiator interface 118 of the router 102 de-asserts the second Master Response Valid signal 244, and the second master or initiator 104B de-asserts the second Master Response Ready signal 246. Although in the illustrated example the only register access response packet destined for the second master or initiator 104B is pktA′, it may be noted that in an example (not shown) in which there were further register access response packets destined for the second master or initiator 104B, such further register access response packets would also be delayed.

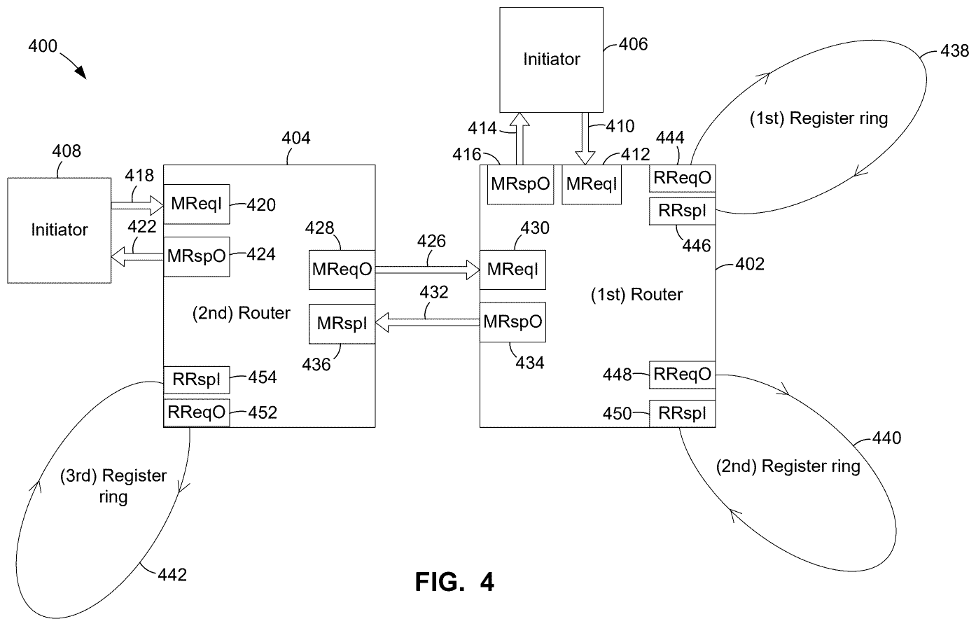

As shown in FIG. 4, in another illustrative or exemplary embodiment a system 400 may include a first router 402 and a second router 404 coupled to each other. Although in the illustrated example the system 400 includes two routers 402 and 404 coupled to each other, in still other examples (not shown) such as system could include more than two such routers coupled to each other. The system 400 may be a portion of an SoC, other portions of which are not shown for purposes of clarity.

Each of the routers 402 and 404 may be similar to the above-described router 102 (FIG. 1). The first router 402 may be coupled to a first initiator 406. The second router 404 may be coupled to a second initiator 408. Although in the illustrated example each of the first and second routers 402 and 404 is coupled to one of the initiators 406 and 408, in other examples (not shown) either or both of two such routers could be coupled to more than one such initiator.

A master request signal path 410 may couple the first initiator 406 to a master request input port (MReqI) 412 of the first router 402. The master request signal path 410 may be similar to the master request signal path 138 or 148, described above with regard to FIG. 1. The master request input port (MReqI) 412 may be similar to the master request input port 120, described above with regard to FIG. 1.

A master response signal path 414 may couple a master response output port (MRspO) 416 of the first router 402 to the first initiator 406. The master response signal path 414 may be similar to the master response signal path 146 or 150, described above with regard to FIG. 1. The master response output port (MRspO) 416 may be similar to the master response output port 122, described above with regard to FIG. 1.

Similarly, another master request signal path 418 may couple the second initiator 408 to a master request input port (MReqI) 420 of the second router 404. The master request signal path 418 may be similar to the master request signal path 138 or 148, described above with regard to FIG. 1. The master request input port (MReqI) 420 may be similar to the master request input port 120, described above with regard to FIG. 1.

Another master response signal path 422 may couple a master response output port (MRspO) 424 of the second router 404 to the second initiator 408. The master response signal path 422 may be similar to the master response signal path 146 or 150, described above with regard to FIG. 1. The master response output port (MRspO) 424 may be similar to the master response output port 122, described above with regard to FIG. 1.

In the system 400, yet another master request signal path 426 may couple a master request output port (MReqO) 428 of the second router 404 to a master request input port (MReqI) 430 of the first router 402. Correspondingly, yet another master response signal path 432 may couple a master response output port (MRspO) 434 of the first router 402 to a master response input port (MRspI) 436 of the second router 404.

The exemplary system 400 may further include first and second register rings 438 and 440 coupled to the first router 402, and a third register ring 442 coupled to the second router 404. The input and output ends of the first register ring 438 may be coupled to a ring request output port 444 and a ring response input port 446, respectively. Similarly, the input and output ends of the second register ring 440 may be coupled to a ring request output port 448 and a ring response input port 450, respectively, while the input and output ends of the third register ring 442 may be coupled to a ring request output port 452 and a ring response input port 454, respectively. Each of the register rings 438, 440 and 442 may have a structure similar to the structure of the above-described register rings 106 (FIG. 1). That is, although not shown in FIG. 4 for purposes of clarity, each of the register rings 438, 440 and 442 may have any number of nodes, each having any number of registers, etc.

Although in the illustrated example two register rings 438 and 440 are coupled to the first router 402, and one register ring 442 is coupled to the second router, in other examples (not shown) any number of such register rings may be coupled to any of such routers. In an example (not shown) having multiple routers located remotely from each other in different regions of the SoC, with a star network-like topology of register rings extending from each router, such a hybrid topology may enable data communication throughout a large area of the SoC while reducing signal path routing congestion.

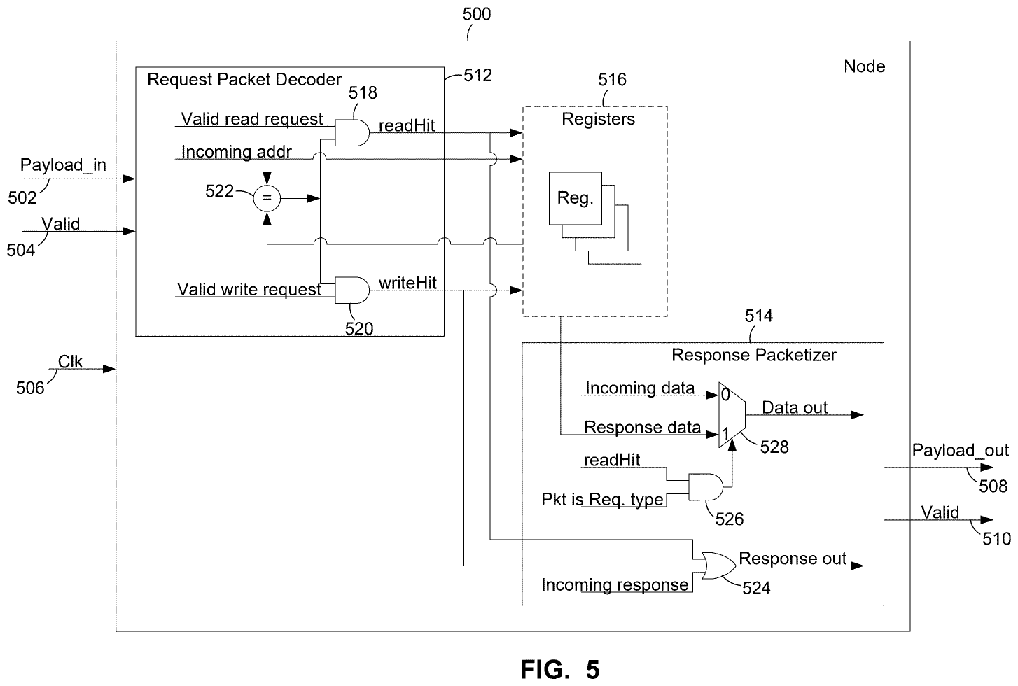

In FIG. 5, an exemplary node 500 is shown in block diagram form. The node 500 may be an example of each of the above-described nodes 108 (FIG. 1). The node 500 may be configured to receive as inputs a payload_in signal 502 and a Valid signal 504, as well as a clock signal 506. Although not shown in FIG. 5 for purposes of clarity, these inputs may be received from a previous node in a register ring or from one of a router's ring request output ports, as described above with regard to the nodes 108 in FIG. 1. The payload represented by the payload_in signal 502 may be a register access request packet or a register access response packet. The Valid signal 504 may indicate an incoming read request or an incoming write request, with that context (i.e., read or write) determined by information indicating a transaction type contained in the register access request packet (payload_in signal 502). The register access request packet may also include an address that uniquely identifies or targets one of the registers 516 of the node 500 or a register (not shown) in a different node. The node 500 may further be configured to provide as outputs a payload_out signal 508 and a Valid signal 510. Although not shown in FIG. 5 for purposes of clarity, these outputs may be provided to a next node in a register ring or to one of a router's ring response input ports, as described above with regard to the nodes 108 in FIG. 1. The payload represented by the payload_out signal 508 may be a register access request packet or a register access response packet.

The node 500 may include request packet decoder circuitry 512, response packetizer circuitry 514, and any number of registers 516. The registers 516 may be of the type referred to as control and status registers or “CSRs.” Although not shown in FIG. 5 for purposes of clarity, the registers 516 may be coupled to any of various SoC logic circuitry components, which may be configured to store data in the registers 516 or read data from the registers 516. The request packet decoder circuitry 512 may include first logical-AND circuitry 518, second logical-AND circuitry 520, and an address comparator 522. The address comparator 522 may be configured to compare the address contained in an incoming register access request packet with the addresses of the registers 516. The first logical-AND circuitry 518 may be configured to indicate that the register access request is a “readHit” when the transaction type contained in the register access request packet indicates a read request, and the address contained in the register access request packet matches the address of one of the registers 516. Similarly, the second logical-AND circuitry 520 may be configured to indicate that the register access request is a “writeHit” when the transaction type contained in the register access request packet indicates a write request, and the address contained in the register access request packet matches the address of one of the registers 516. In response to a writeHit, data contained in the register access request packet (payload) may be written to the addressed or targeted one of the registers 516. In response to a readHit, data (i.e., Response data) may be read from the addressed or targeted one of the registers 516 and used by the response packetizer circuitry 514 to form a register access response packet.

The response packetizer circuitry 514 may include logical-OR circuitry 524, logical-AND circuitry 526, and multiplexing or selection circuitry 528. The logical-OR circuitry 524 may configure the response packetizer circuitry 514 to provide an outgoing register access response packet when the incoming request is determined (as described above with regard to the request packet decoder 512) to be a readHit or a writeHit, or when the incoming packet is not an incoming register access request packet but rather is an incoming register access response packet. Note that when the incoming packet is a register access response packet, the node 500 essentially passes that incoming register access response packet to the next node in the register ring (or, if the node 500 is the last or Nth node in the register ring, to a router). The logical-AND circuitry 526 may be configured to determine data is being read from a register 516 addressed by the incoming register access request packet.

This determination by the logical-AND circuitry 526 may control the type of data provided by the multiplexing or selecting circuitry 528. When it is determined that data is being read from an addressed register 516, the multiplexing or selecting circuitry 528 may provide that data. When it is determined that either an incoming read request is not addressed to any of the registers 516 or that the packet is not a request (but rather is a response) then the multiplexing or selecting circuitry 528 may provide the data contained in the incoming register access response packet. The response packetizer circuitry 514 may be configured to provide an outgoing packet of a type determined by the logical-OR circuitry 524 and containing a payload provided by the multiplexing or selecting circuitry 528. Although signal timing details are not shown, the response packetizer circuitry 514 may assert the Valid signal 510 when it provides a valid outgoing packet.

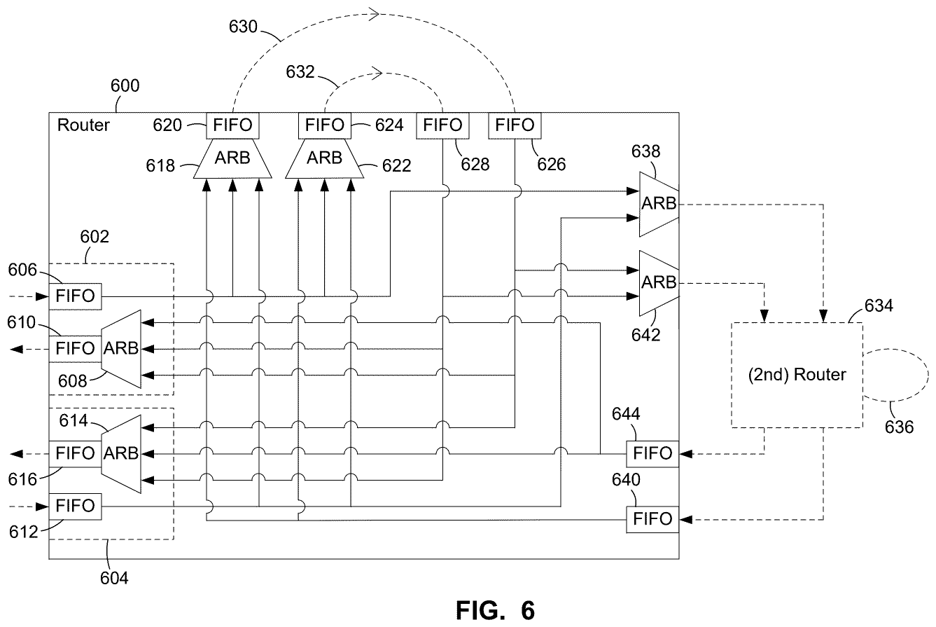

In FIG. 6, an exemplary router 600 is shown in block diagram form. The router 600 may be an example of any of the above-described routers 102, 202, 204, etc. The router 600 may include a first master or initiator interface 602 and a second master or initiator interface 604. The first master or initiator interface 602 may include a FIFO 606 configured to provide a master request input port. That is, the FIFO 606 may be configured to buffer register access request packets received from, for example, a first initiator (not shown). The first master or initiator interface 602 may also include an arbiter 608 and another FIFO 610, together configured to provide a master response output port. Similarly, the second master or initiator interface 604 may include a FIFO 612 configured to provide a master request input port. The second master or initiator interface 604 may also include an arbiter 614 and another FIFO 616, together configured to provide a master response output port. The arbiters 608 and 614 may be configured to perform the above-described arbitration among register access response packets received from the register rings. The FIFOs 610 and 616 may be configured to buffer the register access response packets received from the arbiters 608 and 614.

The router 600 may include an arbiter 618 and a FIFO 620 together configured to provide a first ring request output port, and another arbiter 622 and another FIFO 624 together configured to provide a second ring request output port. The arbiters 618 and 622 may be configured to perform the above-described arbitration among register access request packets provided to the register rings. The FIFOs 620 and 624 may be configured to buffer register access request packets received from the arbiters 618 and 622 before providing them to the register rings.

The router 600 may further include a FIFO 626 and a FIFO 628, configured to provide first and second ring response input ports, respectively. The FIFOs 626 and 628 may be configured to buffer register access response packets received from the register rings. A first register ring 630 (indicated in broken line) may be coupled between the FIFO 620 and the FIFO 626. A second register ring 632 (indicated in broken line) may be coupled between the FIFO 624 and the FIFO 628. In other examples (not shown), such a router may have any number of ring request output ports, each comprising, for example, a FIFO and an arbiter, and any number of corresponding ring response input ports, each comprising, for example, a FIFO.

The router 600 may be coupled to another (e.g., second) router 634, which in turn may be coupled to any number of register rings 636. The routers 600 and 634 may be coupled to each other in the manner described above with regard to the first and second routers 402 and 404 in FIG. 4. For example, the router 600 may include a first arbiter 638 configured to provide a master request output port, and a first FIFO 640 configured to provide a corresponding master response input port. Similarly, the router 600 may include a second arbiter 642 configured to provide a master request output port, and a second FIFO 644 configured to provide a corresponding master response input port.

The arbiter 618 and the arbiter 622 each may be configured to arbitrate among register access request packets received from a first initiator (not shown, but coupled, for example, to the first master or initiator interface 602), a second initiator (not shown, but coupled, for example, the second master or initiator interface 604, and the second router 634 (via the FIFO 640). The arbiters 618 and 622 may also be configured to perform a packet address decoding function. That is, the arbiter 618 may be configured to pass through to the FIFO 620 (and thus to the first register ring 630) only those register access request packets containing an address that matches the address of one of the registers in the first register ring 630. Likewise, the arbiter 622 may be configured to pass through to the FIFO 624 (and thus to the second register ring 632) only those register access request packets containing an address that matches the address of one of the registers in the second register ring 632. The arbiter 608 and the arbiter 614 each may be configured to arbitrate among register access response packets received from the first register ring 630 (via the FIFO 626), the second register ring 632 (via the FIFO 628), and the second router 634 (via the FIFO 644).

The arbiter 638 may be configured to arbitrate between register access request packets received from first and second initiators (not shown but coupled as described above). Register access request packets may thus be routed to the second router 634. The arbiter 642 may be configured to arbitrate between register access request packets received from the first register ring 630 (via the FIFO 626) and from the second register ring 632 (via the FIFO 628).

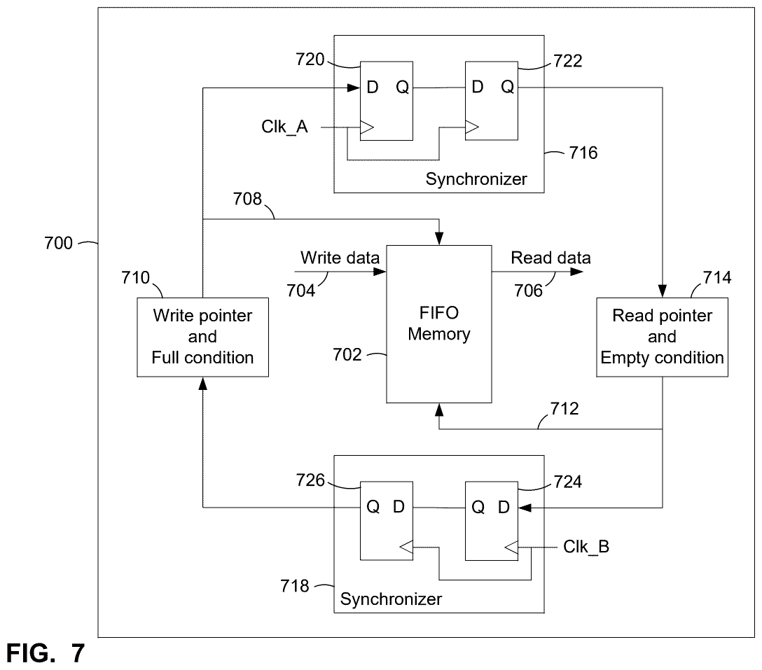

In FIG. 7, a FIFO 700 is shown in block diagram form. The FIFO 700 may be an example of any of the above-described FIFOs. The FIFO 700 may provide a clock domain crossing circuitry feature. In accordance with this feature, data may be written or stored using a first clock signal, and data may be read or retrieved using a second clock signal that is asynchronous to the first clock signal. For example, a router (not shown in FIG. 7) configured to operate using a first clock signal and having the FIFO 700 may be coupled via the FIFO 700 to an initiator configured to operate using a second clock signal that is asynchronous to the first clock signal. Similarly, a router configured to operate using a first clock signal and having the FIFO 700 may be coupled via the FIFO 700 to a register ring configured to operate using a second clock signal that is asynchronous to the first clock signal. Likewise, a router configured to operate using a first clock signal and having the FIFO 700 may be coupled via the FIFO 700 to another router configured to operate using a second clock signal that is asynchronous to the first clock signal. Any of the routers and register rings of a system may operate using any clock signals, some or all of which may be asynchronous to each other (e.g., in different clock domains of an SoC). For example, referring briefly again to FIG. 4, the first router 402, first initiator 406, and first register ring 438 may operate using the same first clock signal (e.g., may be within a first clock domain on the SoC), while the second register ring 440 may operate using a second clock signal that is asynchronous to the first clock signal (e.g., may be within a second clock domain on the SoC), and the second router 404, the second initiator 408, and the third register ring 442 may operate using a third clock signal that is asynchronous to the first and second clock signals (e.g., may be within a third clock domain on the SoC).

The FIFO 700 may include a FIFO memory 702, configured to store (i.e., write) and retrieve (i.e., read) data in a first-in-first-out order. The FIFO memory 702 may be configured to receive data 704 to be written and to provide data 706 that has been read. A write pointer 708 provided by write pointer and Full-condition logic 710 indicates the next location to be written to in the FIFO memory 702. A read pointer 712 provided by read pointer and Empty-condition logic 714 indicates the next location to be read from in the FIFO memory 702. The write pointer and Full-condition logic 710 may also be configured to determine when the FIFO memory 702 is full. The read pointer 712 provided by read pointer and Empty-condition logic 714 may also be configured to determine when the FIFO memory 702 is empty.

The FIFO 700 may also include first synchronizer logic 716 and second synchronizer logic 718. The first synchronizer logic 716 may include a pair of pipelined flip-flops 720 and 722, each operating using a first clock signal (Clk_A). The first synchronizer logic 716 may be configured to synchronize the output of the write pointer and Full-condition logic 710 with the first clock signal and to provide the resulting synchronized signal to the read pointer and Empty-condition logic 714. The second synchronizer logic 718 may similarly include a pair of pipelined flip-flops 724 and 726, each operating using a second clock signal (Clk_B). The second synchronizer logic 718 may be configured to synchronize the output of the read pointer and Empty-condition logic 714 with the second clock signal and to provide the resulting synchronized signal to the write pointer and Full-condition logic 710.

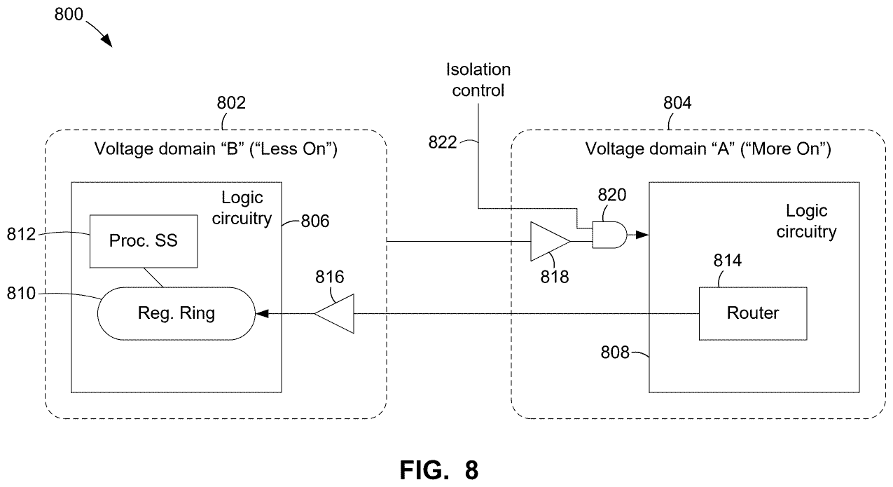

As shown in FIG. 8, a system 800 may provide a voltage domain crossing feature. An SoC (not shown) may have multiple power or voltage domains, and portions of the core logic of the SoC may reside in the various voltage domains. For example, an SoC may have a first voltage domain 802 and a second voltage domain 804. The first voltage domain 802 may comprise first logic circuitry 806. The second voltage domain 804 may comprise second logic circuitry 808. In relation to the solutions described herein, the first logic circuitry 806 may include, for example, a register ring 810 and a processing subsystem 812 or logic circuitry component configured to access registers (not separately shown) of the register ring 810. The second logic circuitry 808 may include, for example, a router 814 coupled to the register ring 810 in the manner described above with regard to, for example, FIGS. 1, 4 and 6. A voltage level shifter 816 may be included in a signal path between the router 814 and register ring 810. It should be understood that when the chip (e.g., SoC) is powered up, the voltage domains 802 and 804 may be powered up sequentially. For example, the power-up sequence may be voltage domain 804 powers up first, followed by voltage domain 802. In an example in which voltage domain 804 powers up first and voltage domain 802 powers up after voltage domain 804, the term “More On” may be used to refer to voltage domain 804 relative to voltage domain 802, and the term “Less On” may be used to refer to voltage domain 802 relative to voltage domain 804. In this example, if a signal were to be sent from voltage domain 804 to voltage domain 802, since voltage domain 804 is More On, the signal driven from 804 to voltage domain 802 cannot be unknown/indeterministic, so no isolation cells are needed. However, since voltage domains 804 and 802 may be on two separate voltage domains, a voltage level shifter 816 may be needed to maintain the drive strength of the incoming signal from voltage domain 804 in voltage domain 802. Although in the illustrated example the router 814 is in a different voltage domain from the register ring 810, in another example (not shown) the router 814 could be in a different voltage domain from another router to which the router 814 is coupled. For example, referring briefly again to FIG. 4, the first router 402, first initiator 406, and first register ring 438 may all be within a first voltage domain on the SoC, while the second register ring 440 may be within a second voltage domain on the SoC, and the second router 404, the second initiator 408, and the third register ring 442 may be within a third voltage domain on the SoC).

In the scenario of the signals driven from voltage domain 802 to voltage domain 804 where 802 is Less On compared to voltage domain 804, while voltage domain 802 is in OFF state, the signals will have unknown/indeterministic data driven into voltage domain 804 which is powered ON. The unknown data from voltage domain 802 can take the logic circuitry in voltage domain 804 into an unexpected behavior. To address this scenario, an isolation cell 820 may also be included in this signal path and may be configured to clamp the output of the isolation cell 820 to a deterministic (i.e., not undefined) value. This clamp value may be a benign value that does not trigger downstream logic (not shown). The isolation cell 820 may perform the clamping based on an isolation control signal 822, which may be driven by logic circuitry (not shown) that controls the chip's power sequencing. A voltage level shifter 818 may be included to maintain the drive strength of the incoming signal from voltage domain 802 to voltage domain 804.

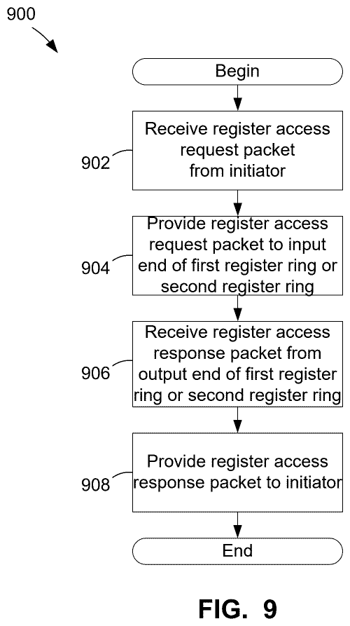

In FIG. 9, an exemplary method 900 for data communication in an SoC is shown in flow diagram form. As indicated by block 902, a register access request packet may be received from an initiator. This receiving may be performed by, for example, a master request input port of a router. As indicated by block 904, the register access request packet may be provided to a ring input end of a first register ring or a second register ring. This providing of the register access request packet to a ring input end of a first register ring or a second register ring may be performed by, for example, a ring request output port. Although not shown in FIG. 9, in some examples of operation a “broadcast mode” may be provided, in which the same register access request packet may be routed to two or more register rings. As indicated by block 906, a register access response packet may be received from a ring output end of the first register ring or the second register ring. Receiving the register access response packet may be performed by, for example, a ring response input port. As indicated by block 908, the register access response packet may be provided to the initiator. Providing the register access response packet to the initiator may be performed by, for example, a master response output port of the router. Although for purposes of clarity the method 900 illustrates an example of operation involving only one initiator, it may be appreciated that the method 900 may be extended to operation involving two (or more) initiators.

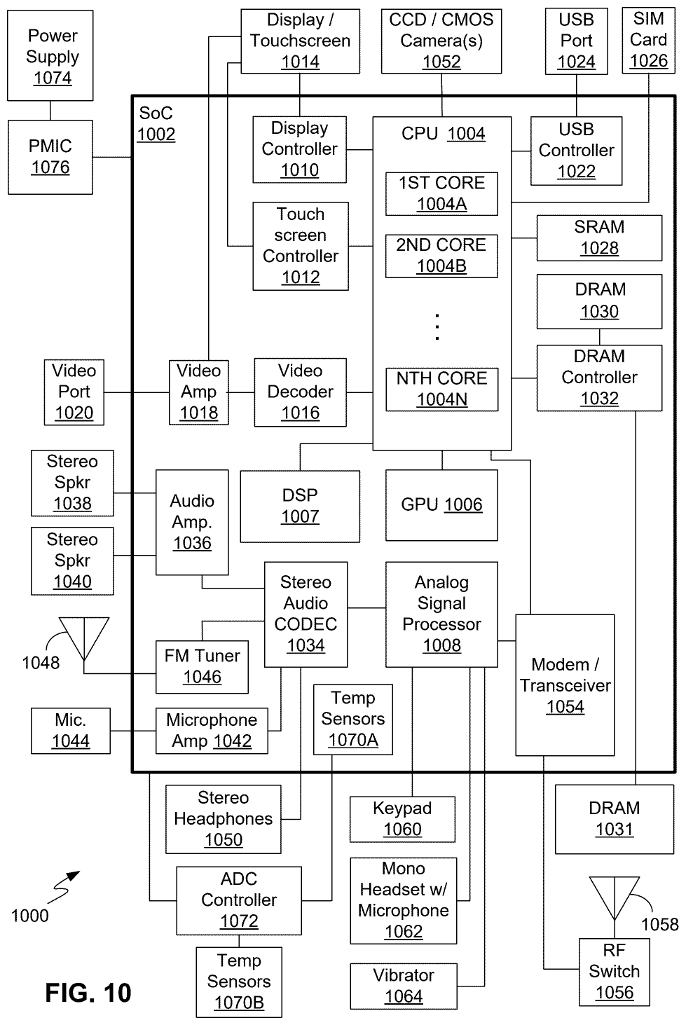

FIG. 10 illustrates an example of a portable computing device (PCD) 1000, in which exemplary embodiments of systems, methods, and other examples of networked data communication in an SoC may be provided. The PCD 1000 may be, for example, a laptop or palmtop computer, cellular telephone or smartphone, personal digital assistant, navigation device, smartbook, portable game console, satellite telephone, automotive device, Internet-of-Things (IoT) device, etc.

The PCD 1000 may include an SoC 1002. The SoC 1002 may include a CPU 1004, a GPU 1006, a digital signal processor (DSP) 1007, an analog signal processor 1008, a modem/modem subsystem 1054, or other processors. The CPU 1004 may include one or more CPU cores, such as a first CPU core 1004A, a second CPU core 1004B, etc., through an Nth CPU core 1004N.

Although not shown in FIG. 10 for purposes of clarity, the SoC 1002 may include a ring-based interconnect in accordance with the descriptions herein. That is, one or more routers may be distributed about the physical area of the SoC 1002, e.g., in different regions of the SoC 1002, and each router may be coupled to one or more register rings. Nodes of the register rings may be located in proximity to various SoC subsystems or components, such as the CPU 1004, GPU 1006, DSP 1007, analog signal processor 1008, modem/modem subsystem 1054, etc., which may be configured to access control and status registers (CSRs) of the nodes. Some subsystems, such as CPU cores, may be configured as transaction initiators.

A display controller 1010 and a touch-screen controller 1012 may be coupled to the CPU 1004. A touchscreen display 1014 external to the SoC 1002 may be coupled to the display controller 1010 and the touch-screen controller 1012. The PCD 1000 may further include a video decoder 1016 coupled to the CPU 1004. A video amplifier 1018 may be coupled to the video decoder 1016 and the touchscreen display 1014. A video port 1020 may be coupled to the video amplifier 1018. A universal serial bus (USB) controller 1022 may also be coupled to CPU 1004, and a USB port 1024 may be coupled to the USB controller 1022. A subscriber identity module (SIM) card 1026 may also be coupled to the CPU 1004.

The CPU 1004 may be coupled to one or more memories, with which the CPU 1004 or other processors may initiate memory transactions. The one or more memories may include both volatile and non-volatile memories. Examples of volatile memories include static random access memory (SRAM) 1028 and dynamic random access memories (DRAM) 1030 and 1031. Such memories may be internal to the SoC 1002, as in the case of the DRAM 1030, or external to the SoC 1002, as in the case of the DRAM 1031. A DRAM controller 1032 coupled to the CPU 1004 may control the writing of data to, and reading of data from, the DRAM 1030.

A stereo audio CODEC 1034 may be coupled to the analog signal processor 1008. Further, an audio amplifier 1036 may be coupled to the stereo audio CODEC 1034. First and second stereo speakers 1038 and 1040, respectively, may be coupled to the audio amplifier 1036. In addition, a microphone amplifier 1042 may be coupled to the stereo audio CODEC 1034, and a microphone 1044 may be coupled to the microphone amplifier 1042. A frequency modulation (FM) radio tuner 1046 may be coupled to the stereo audio CODEC 1034. An FM antenna 1048 may be coupled to the FM radio tuner 1046. Further, stereo headphones 1050 may be coupled to the stereo audio CODEC 1034. Other devices that may be coupled to the CPU 1004 include one or more digital (e.g., CCD or CMOS) cameras 1052.

The RF transceiver or modem subsystem 1054 may be coupled to the analog signal processor 1008 and the CPU 1004. An RF switch 1056 may be coupled to the modem subsystem 1054 and an RF antenna 1058. In addition, a keypad 1060, a mono headset with a microphone 1062, and a vibrator device 1064 may be coupled to the analog signal processor 1008.

The SoC 1002 may have one or more internal or on-chip thermal sensors 1070A and may be coupled to one or more external or off-chip thermal sensors 1070B. An analog-to-digital converter controller 1072 may convert voltage drops produced by the thermal sensors 1070A and 1070B to digital signals. A power supply 1074 and a power management integrated circuit (PMIC) 1076 may supply power to the SoC 1002.

Implementation examples are described in the following numbered clauses:
1. A system for data communication in a system-on-chip (SoC), comprising:
   a first router in the SoC, the first router having a master request input port configured to receive register access request packets from an initiator and a master response output port configured to provide register access response packets to the initiator, the first router further having a first ring interface including a first ring request output port and a first ring response input port, the first router still further having a second ring interface including a second ring request output port and a second ring response input port; and
   a plurality of register rings in the SoC, including a first register ring and a second register ring, each register ring having a unidirectional data communication path between a ring input end and a ring output end, each register ring having at least one register in the unidirectional data communication path configured to receive register access request packets addressed to the register, the ring input end of the first register ring coupled to the first ring request output port, the ring output end of the first register ring coupled to the first ring response input port, the ring input end of the second register ring coupled to the second ring request output port, the ring output end of the second register ring coupled to the second ring response input port.
2. The system of clause 1, further comprising:
   a second router having a master request input port and a master response output port, and wherein the first router further includes a master request output port and a master response input port, the master request output port of the first router coupled to the master request input port of the second router and configured to provide the register access request packets, the master request input port of the first router coupled to the master response output port of the second router and configured to receive the register access response packets; and
   a third register ring of the plurality of register rings, the ring input end of the third register ring coupled to a ring request output port of the second router, the ring output end of the second register ring coupled to a ring response input port of the second router.
3. The system of clause 1 or 2, wherein the first router is in a different clock domain or a different voltage domain from at least one of the first and second register rings.
4. The system of any of clauses 1-3, wherein each ring interface includes an arbiter configured to arbitrate among register access request packets received from a plurality of initiators.
5. The system of any of clauses 1-4, wherein each ring interface includes a first-in-first-out (FIFO) buffer.
6. The system of any of clauses 1-5, wherein:
   the master request input port is configured to receive a register access request packet from the initiator when the master request input port provides an asserted Master Request Ready signal to the initiator and the master request input port receives an asserted Master Request Valid signal from the initiator; and
   the master response output port is configured to provide a register access response packet to the initiator when the master response output port provides an asserted Master Response Valid signal to the initiator and the master response output port receives an asserted Master Response Ready signal from the initiator.
7. The system of any of clauses 1-6, wherein:
   the first ring request output port is configured to provide the register access request packet to the ring input end of the first register ring while providing an asserted first Ring Request Valid signal to the ring input end of the first register ring;
   the second ring request output port is configured to provide the register access request packet to the ring input end of the second register ring while providing an asserted second Ring Request Valid signal to the ring input end of the second register ring;
   the first ring response input port is configured to receive the register access response packet from the ring output end of the first register ring when a first Ring Response Valid signal is asserted; and
   the second ring response input port is configured to receive the register access response packet from the ring output end of the second register ring when a second Ring Response Valid signal is asserted.
8. A method for data communication in a system-on-chip (SoC), comprising:
   receiving, by a master request input port of a first router in the SoC, a register access request packet from an initiator;
   providing, by at least one of a first ring request output port of a first ring interface and a second ring request output port of a second ring interface, the register access request packet to a ring input end of one of a first register ring and a second register ring;
   receiving, by one of a first ring response input port of the first ring interface and a second ring response input port of the second ring interface, a register access response packet from a ring output end of one of the first register ring and the second register ring; and
   providing, by a master response output port of the first router, the register access response packet to the initiator.
9. The method of clause 8, further comprising:
   providing, by a master request output port of the first router, the register access request packet to a master request input port of a second router;
   providing, by a third ring request output port of the second router, the register access request packet to a ring input end of a third register ring; and
   receiving, by a third ring response input port of the second router, the register access response packet from a ring output end of the third register ring; and
   receiving, by a master response input port of the first router, the register access request packet from a master response output port of the second router.
10. The method of clause 8 or 9, wherein the first router is in a different clock domain or a different voltage domain from at least one of the first and second register rings.
11. The method of any of clauses 8-10, further comprising, arbitrating, by an arbiter of each ring interface, among a plurality of register access request packets received from a plurality of initiators.
12. The method of any of clauses 8-11, further comprising, buffering, by a first-in-first-out (FIFO) buffer of each ring interface, a plurality of register access request packets.
13. The method of any of clauses 8-12, wherein:
   receiving the register access request packet from the initiator includes providing, by the master request input port, an asserted Master Request Ready signal to the initiator, and receiving, by the master request input port, an asserted Master Request Valid signal from the initiator; and
   providing the register access response packet to the initiator include providing, by the master response output port, an asserted Master Response Valid signal to the initiator, and receiving, by the master response output port, an asserted Master Response Ready signal from the initiator.
14. The method of any of clauses 8-13, wherein:
   providing the register access request packet to the ring input end of one of the first register ring and the second register ring includes providing an asserted Ring Request Valid signal to the ring input end of the one of the first register ring and the second register ring;
   receiving the register access response packet includes receiving a Ring Response Valid signal from the ring output end of the one of the first register ring and the second register ring.
15. A system-on-chip (SoC), comprising:
   a plurality of registers;
   a plurality of logic circuitry components configured to access the plurality of registers; and
   a first router, the first router having a master request input port configured to receive register access request packets from an initiator addressed to the plurality of registers and a master response output port configured to provide register access response packets to the initiator, the first router further having a first ring interface including a first ring request output port and a first ring response input port, the first router still further having a second ring interface including a second ring request output port and a second ring response input port;
   wherein the plurality of registers are included in a plurality of register rings including a first register ring and a second register ring, each register ring having at least one of the plurality of registers in a unidirectional data communication path between a ring input end and a ring output end, the ring input end of the first register ring coupled to the first ring request output port, the ring output end of the first register ring coupled to the first ring response input port, the ring input end of the second register ring coupled to the second ring request output port, the ring output end of the second register ring coupled to the second ring response input port.
16. The SoC of clause 15, further comprising:
   a second router having a master request input port and a master response output port, and wherein the first router further includes a master request output port and a master response input port, the master request output port of the first router coupled to the master request input port of the second router and configured to provide the register access request packets, the master request input port of the first router coupled to the master response output port of the second router and configured to receive the register access response packets; and
   a third register ring of the plurality of register rings, the ring input end of the third register ring coupled to a ring request output port of the second router, the ring output end of the second register ring coupled to a ring response input port of the second router.
17. The SoC of clause 15 or 16, wherein the first router is in a different clock domain or voltage domain from at least one of the first and second register rings.
18. The SoC of any of clauses 15-17, wherein each ring interface includes an arbiter configured to arbitrate among register access request packets received from a plurality of initiators.
19. The SoC of any of clauses 15-18, wherein each ring interface includes a first-in-first-out (FIFO) buffer.
20. The SoC of any of clauses 15-19, wherein:
   the master request input port is configured to receive a register access request packet from the initiator when the master request input port provides an asserted Master Request Ready signal to the initiator and the master request input port receives an asserted Master Request Valid signal from the initiator; and
   the master response output port is configured to provide a register access response packet to the initiator when the master response output port provides an asserted Master Response Valid signal to the initiator and the master response output port receives an asserted Master Response Ready signal from the initiator.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A system for data communication in a system-on-chip (SoC), comprising:
a first router in the SoC, the first router having a master request input port configured to receive register access request packets from an initiator and a master response output port configured to provide register access response packets to the initiator, the first router further having a first ring interface including a first ring request output port and a first ring response input port, the first router still further having a second ring interface including a second ring request output port and a second ring response input port; and
a plurality of register rings in the SoC, including a first register ring and a second register ring, each register ring having a unidirectional data communication path between a ring input end and a ring output end, each register ring having at least one register in the unidirectional data communication path configured to receive register access request packets addressed to the register, the ring input end of the first register ring coupled to the first ring request output port, the ring output end of the first register ring coupled to the first ring response input port, the ring input end of the second register ring coupled to the second ring request output port, the ring output end of the second register ring coupled to the second ring response input port.

2. The system of claim 1, further comprising:
a second router having a master request input port and a master response output port, and wherein the first router further includes a master request output port and a master response input port, the master request output port of the first router coupled to the master request input port of the second router and configured to provide the register access request packets, the master request input port of the first router coupled to the master response output port of the second router and configured to receive the register access response packets; and
a third register ring of the plurality of register rings, the ring input end of the third register ring coupled to a ring request output port of the second router, the ring output end of the second register ring coupled to a ring response input port of the second router.

3. The system of claim 1, wherein the first router is in a different clock domain or a different voltage domain from at least one of the first and second register rings.

4. The system of claim 1, wherein each ring interface includes an arbiter configured to arbitrate among register access request packets received from a plurality of initiators.

5. The system of claim 1, wherein each ring interface includes a first-in-first-out (FIFO) buffer.

6. The system of claim 1, wherein:
the master request input port is configured to receive a register access request packet from the initiator when the master request input port provides an asserted Master Request Ready signal to the initiator and the master request input port receives an asserted Master Request Valid signal from the initiator; and
the master response output port is configured to provide a register access response packet to the initiator when the master response output port provides an asserted Master Response Valid signal to the initiator and the master response output port receives an asserted Master Response Ready signal from the initiator.

7. The system of claim 1, wherein:
the first ring request output port is configured to provide the register access request packet to the ring input end of the first register ring while providing an asserted first Ring Request Valid signal to the ring input end of the first register ring;
the second ring request output port is configured to provide the register access request packet to the ring input end of the second register ring while providing an asserted second Ring Request Valid signal to the ring input end of the second register ring;
the first ring response input port is configured to receive the register access response packet from the ring output end of the first register ring when a first Ring Response Valid signal is asserted; and
the second ring response input port is configured to receive the register access response packet from the ring output end of the second register ring when a second Ring Response Valid signal is asserted.

8. A method for data communication in a system-on-chip (SoC), comprising:
receiving, by a master request input port of a first router in the SoC, a register access request packet from an initiator;
providing, by at least one of a first ring request output port of a first ring interface and a second ring request output port of a second ring interface, the register access request packet to a ring input end of one of a first register ring and a second register ring;
receiving, by one of a first ring response input port of the first ring interface and a second ring response input port of the second ring interface, a register access response packet from a ring output end of one of the first register ring and the second register ring; and
providing, by a master response output port of the first router, the register access response packet to the initiator.

9. The method of claim 8, further comprising:
providing, by a master request output port of the first router, the register access request packet to a master request input port of a second router;
providing, by a third ring request output port of the second router, the register access request packet to a ring input end of a third register ring; and
receiving, by a third ring response input port of the second router, the register access response packet from a ring output end of the third register ring; and
receiving, by a master response input port of the first router, the register access request packet from a master response output port of the second router.

10. The method of claim 8, wherein the first router is in a different clock domain or a different voltage domain from at least one of the first and second register rings.

11. The method of claim 8, further comprising, arbitrating, by an arbiter of each ring interface, among a plurality of register access request packets received from a plurality of initiators.

12. The method of claim 8, further comprising, buffering, by a first-in-first-out (FIFO) buffer of each ring interface, a plurality of register access request packets.

13. The method of claim 8, wherein:
receiving the register access request packet from the initiator includes providing, by the master request input port, an asserted Master Request Ready signal to the initiator, and receiving, by the master request input port, an asserted Master Request Valid signal from the initiator; and
providing the register access response packet to the initiator include providing, by the master response output port, an asserted Master Response Valid signal to the initiator, and receiving, by the master response output port, an asserted Master Response Ready signal from the initiator.

14. The method of claim 8, wherein:
providing the register access request packet to the ring input end of one of the first register ring and the second register ring includes providing an asserted Ring Request Valid signal to the ring input end of the one of the first register ring and the second register ring;
receiving the register access response packet includes receiving a Ring Response Valid signal from the ring output end of the one of the first register ring and the second register ring.

15. A system-on-chip (SoC), comprising:
a plurality of registers;
a plurality of logic circuitry components configured to access the plurality of registers; and
a first router, the first router having a master request input port configured to receive register access request packets from an initiator addressed to the plurality of registers and a master response output port configured to provide register access response packets to the initiator, the first router further having a first ring interface including a first ring request output port and a first ring response input port, the first router still further having a second ring interface including a second ring request output port and a second ring response input port;
wherein the plurality of registers are included in a plurality of register rings including a first register ring and a second register ring, each register ring having at least one of the plurality of registers in a unidirectional data communication path between a ring input end and a ring output end, the ring input end of the first register ring coupled to the first ring request output port, the ring output end of the first register ring coupled to the first ring response input port, the ring input end of the second register ring coupled to the second ring request output port, the ring output end of the second register ring coupled to the second ring response input port.

16. The SoC of claim 15, further comprising:
a second router having a master request input port and a master response output port, and wherein the first router further includes a master request output port and a master response input port, the master request output port of the first router coupled to the master request input port of the second router and configured to provide the register access request packets, the master request input port of the first router coupled to the master response output port of the second router and configured to receive the register access response packets; and
a third register ring of the plurality of register rings, the ring input end of the third register ring coupled to a ring request output port of the second router, the ring output end of the second register ring coupled to a ring response input port of the second router.

17. The SoC of claim 15, wherein the first router is in a different clock domain or voltage domain from at least one of the first and second register rings.

18. The SoC of claim 15, wherein each ring interface includes an arbiter configured to arbitrate among register access request packets received from a plurality of initiators.

19. The SoC of claim 15, wherein each ring interface includes a first-in-first-out (FIFO) buffer.

20. The SoC of claim 15, wherein:
the master request input port is configured to receive a register access request packet from the initiator when the master request input port provides an asserted Master Request Ready signal to the initiator and the master request input port receives an asserted Master Request Valid signal from the initiator; and
the master response output port is configured to provide a register access response packet to the initiator when the master response output port provides an asserted Master Response Valid signal to the initiator and the master response output port receives an asserted Master Response Ready signal from the initiator.
